(19) United States
(12) Patent Application Publication
(10) Pub. No.: US 2017/0129760 A1
(43) Pub. Date: May 11, 2017

(54) METHOD AND APPARATUS FOR CLEANING BEVERAGE DISPENSERS

(71) Applicant: Sea Hawk Systems, LLC, Fort Lauderdale, FL (US)

(72) Inventors: John M. ANESON, Fort Lauderdale, FL (US); Raymond J. McCAUSLAND, Gibbsboro, NJ (US)

(21) Appl. No.: 14/935,664

(22) Filed: Nov. 9, 2015

(51) Int. Cl. B67D 1/07; B67D 1/00; B08B 3/02; B08B 3/10; B08B 9/00; B67D 1/08; B08B 3/08

(52) U.S. Cl. CPC B67D 1/07; B67D 1/0889; B67D 1/0084; B08B 3/08; B08B 3/10; B08B 9/00; B08B 3/02

(57) ABSTRACT

A method and apparatus cleans plurality of beverage dispensers which sit in respective holsters. Cleaning solution conduits are oriented to spray cleaning solution towards respective tops of holsters. One or more fluid valves or pumps alternatively permit and block said cleaning solution to flow to said cleaning solution conduits, respectively. A power supply flow signals to the fluid valve or pump, respectively, wherein the valve or pump transitions between permitting and blocking flow responsive to transitioning of the flow signals, respectively. A transmitter signals the power supply to transition the flow signals to cause the fluid valve or pump to permit the cleaning solution to flow to the cleaning solution conduits.

### FIELD OF THE INVENTION

The present invention relates to beverage dispensers, and in particular to the cleaning of beverage dispensers. Specifically, a method and apparatus are disclosed for cleaning a dispenser which dispenses beverages.

### BACKGROUND OF THE INVENTION

Restaurants, bars, and other types of food establishments use a dispenser in order to dispense beverages. FIG. 1 illustrates an exemplary prior art device which is used to dispense beverages and which is identified by several different names including a bar dispenser, a bar gun, and a soda gun. Dispenser 100 includes housing 104 with several pushbuttons 108 mounted thereon. Depending upon which pushbutton 108 is depressed, one of several beverages are dispensed (into a glass for example) via nozzle 106.

Dispenser 100 is coupled to a plurality of different beverages (or beverage ingredients) via inlet hose 102. Within inlet hose 102, a plurality of tubes (not shown) receive beverages (or beverage ingredients) from different sources. For example, one of the tubes within inlet hose 102 may be connected to a water source so that water can be dispensed from dispenser 100. Another tube within inlet hose 102 may be connected to a source of carbonated water. Other tubes within inlet hose 102 may be connected to containers storing concentrated beverage ingredients (e.g. concentrated soda flavorings). Dispenser 100 may mix one of the beverage ingredients with carbonated water to produce various types of flavored sodas (for example).

Pushbuttons 108 thus each correspond to various beverages such as water, carbonated water, or various flavored sodas. If pushbutton 108 corresponding to water or carbonated water is depressed, then water or carbonated water is dispensed through nozzle 106. If pushbutton 108 corresponding to a flavored soda is depressed, then concentrated soda flavoring and carbonated water are mixed within dispenser 100 and dispensed through nozzle 106. An exemplary dispenser is disclosed in Schroeder, U.S. Pat. No. 7,658,006, which is hereby incorporated by reference in its entirety.

At least some of the concentrated soda flavorings received by dispenser 100 include corn syrup as a sweetener. Thus, as various flavored sodas are dispensed from nozzle 106, a residue which includes corn syrup remains on various surfaces of nozzle 106. Over time, the residue builds and nozzle 106 becomes unsanitary.

### SUMMARY OF THE INVENTION

A method and apparatus cleans a plurality of beverage dispensers which sit in respective holsters. Cleaning solution conduits are oriented to spray cleaning solution towards respective tops of holsters. At least one fluid valve and/or pump alternatively permits and blocks a cleaning solution to flow to the cleaning solution conduits, respectively. A power supply provides flow signals to the at least one fluid valve and/or pump, respectively, wherein the valve(s) and/or pump transitions between permitting and not permitting flow of cleaning solution responsive to transitioning of the flow signals, respectively. A transmitter signals the power supply to transition the flow signals to cause the fluid valve(s) and/or pump to permit the cleaning solution to flow to the cleaning solution conduits

### BRIEF DESCRIPTION OF THE DRAWINGS

FIG. 1 is a perspective drawing of a prior art beverage dispenser.

FIG. 2 is a cutaway drawing of a holster for storing a beverage dispenser in accordance with an exemplary embodiment of the present invention.

FIG. 3 illustrates multiple holsters for storing and cleaning multiple beverage dispensers, respectively, in accordance with an exemplary embodiment of the present invention.

FIG. 4 is a block diagram which illustrates a cleaning apparatus for cleaning one or more beverage dispensers in accordance with an exemplary embodiment of the present invention.

FIG. 5A is a block diagram which illustrates a portion of a system which delivers a cleaning solution that is used to clean one or more beverage dispensers in accordance with an exemplary embodiment of the present invention.

FIG. 5B is a block diagram which illustrates a portion of a system which delivers a cleaning solution that is used to clean one or more beverage dispensers in accordance with a further exemplary embodiment of the present invention.

FIG. 6 is flowchart diagram which illustrates an algorithm which is used to clean one or more beverage dispensers in accordance with an exemplary embodiment of the present invention.

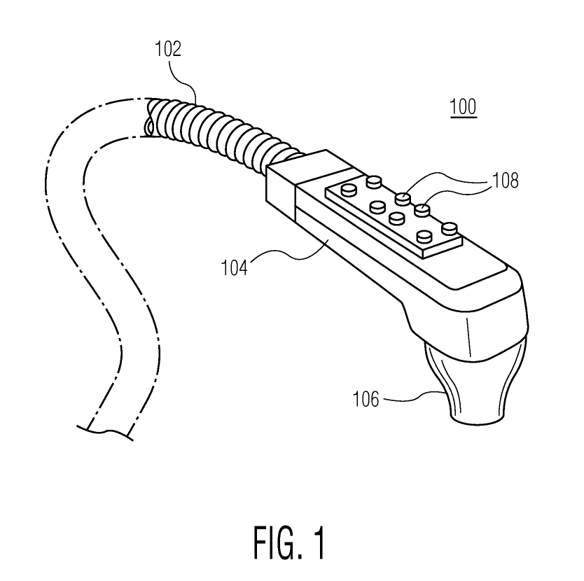

### DETAILED DESCRIPTION OF THE INVENTION

Over time, as dispenser 100 is used, residue builds on surfaces of nozzle 106, and that residue may have adverse consequences. Bacteria and/or mold may grow on the residue. The residue may attract insects such as fruit flies. When beverages are contaminated with bacteria, mold or insects, the beverages can cause sickness and disease. Furthermore, the taste of the beverage being dispensed through the residue may be adversely affected. The residue can block beverages flowing through nozzle 106, thus reducing the flow rate of beverages being dispensed. This may increase the amount of time needed to dispense beverages. Residue creating a blockage within dispenser 100 can alter the ratio of carbonated water and concentrated soda flavoring which are mixed together, thus causing a flavored soda to be dispensed which has either not enough flavoring or too much flavoring; the result is the dispensing of a beverage which does not have its expected taste. A buildup of debris over time can also shorten equipment life.

The residue which collects on surfaces of nozzle 106 can thus have numerous consequences, including:
1) If beverages do not taste good, then customers are dissatisfied, and they may stop purchasing beverages at the establishment that is selling the beverages (or may even stop being customers of the establishment entirely). Furthermore, poor reviews of the establishment may appear on social media if the beverages do not taste good;
2) The residue on the surfaces of the dispenser looks unappealing and unappetizing, and customers will not want to purchase or drink beverages dispensed through the residue;
3) A “board of health” type of inspection of dispenser 100 may result in a government entity prohibiting use of the dispenser until it has been adequately cleaned;
4) If the residue slows down beverage dispensing, then the rate at which beverages are sold may be reduced. This reduction can adversely affect profits.
5) The residue can cause soda to be dispensed with not enough or too much carbonated water.
6) The residue can shorten equipment life.

It is thus desirable for nozzle 106 to be clean and for any residue which appears on nozzle 106 to be removed.

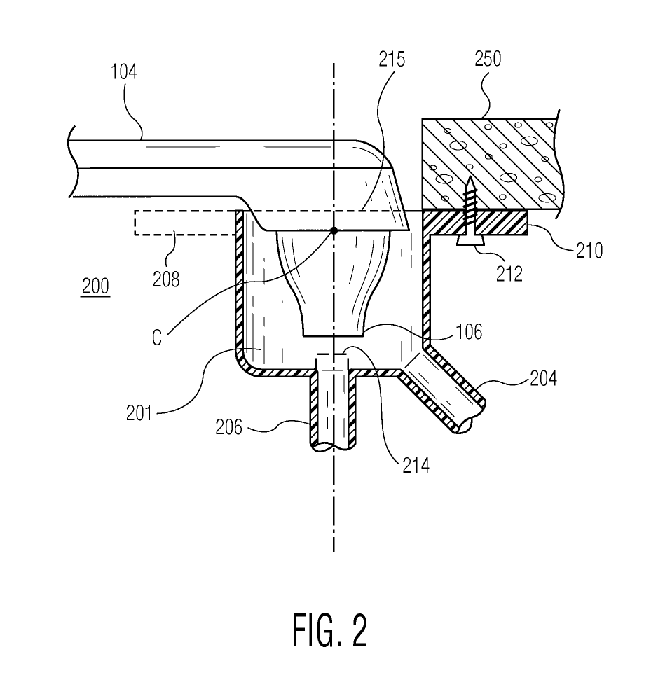

In a bar setting, and as shown in FIG. 2, nozzle 106 of dispenser 100 typically sits in holster 200. Holster 200 is a cup-like member which is attached to the bar. Nozzle 106 is inserted into the upward facing opening of holster. Buttons 108 thus face upwards towards the bar tender (for example). The bartender grabs dispenser 100 via housing 104 and pulls upwards, thus removing nozzle 106 from holster 200. Nozzle 106 is then held over a glass while the bartender pushes the button 108 corresponding to the beverage which is desired to be dispensed. When a sufficient amount of the beverage has been dispensed into the glass, button 108 is released and nozzle 106 of dispenser 100 may be reinserted into holster 200 until it is needed again.

As shown in FIG. 2, holster 200 is a substantially concave member with compartment 201 which receives nozzle 106 of dispenser 100. The weight of dispenser 100 may keep nozzle 106 within compartment 201. Holster 200 may optionally include front ledge 208 which supports housing 104 and thus provides additional support to dispenser 100. Back ledge 210 may also be included. Fastener 212 may extend through back ledge 210 thus attaching holster 200 to counter 250. While customers are seated (or standing) on one side of counter 250, dispenser 100, other bottled beverages, glassware, ice, etc. are situated on the other side of counter 250 where a bartender may serve beverages to the customers.

With reference to FIG. 2, nozzle 106 enters holster 200 via opening 205 in the top of holster 200. Nozzle 106 descends from opening 205 into compartment 201 until the top of holster 200 makes contact with housing 104 so that dispenser 100 is at rest with nozzle 106 within holster 200. When use of dispenser 100 is desired, dispenser 100 is lifted so that nozzle 106 is withdrawn from holster 200.

In an exemplary embodiment of the present invention, a mechanism (not shown) may be used to assist keeping nozzle 106 within holster 200. For example, dispenser 100 and holster 200 may each include respective magnets which attract each other and therefore keep dispenser 100 in holster 100. Holster 100 may alternatively include a tab which extends along the side and top of dispenser 100 and which helps to keep nozzle 106 within holster 200.

While the mechanism described above may be used to assist keeping nozzle 106 within holster 200, there may be disadvantages of such a mechanism as well. For example, dispenser 100 may be inserted into holster 200 and withdrawn from holster 200 multiple times over a short period of time. If a bar tender is serving a large number of customers, the bar tender may need to insert dispenser 100 into holster 200 very quickly. Alternatively, the bar tender may need to withdraw dispenser 100 from holster 200 very quickly. In such a situation, it may be desirable to not have any mechanical mechanisms which assists in keeping dispenser 100 in holster 200. Thus, for example, it may be desirable for the shape of nozzle 106 to simply guide dispenser 100 into holster 200. Once nozzle 106 has been guided into holster 200, it may be desirable for only the weight of dispenser 100 to keep dispenser 100 (or a portion thereof such as nozzle 106) mated to holster 200. By using only the weight of dispenser 100 to keep dispenser 100 mated to holster 200, dispenser 100 can be withdrawn from holster 200 very quickly.

Holster 200 includes outlet 204. Outlet 204 permits any liquids within compartment 201 to drain out. A tube may be connected to outlet 204 and the tube may lead to a drain, such as a public drain provided by a municipality. It is thus desirable that any liquids within compartment 201 be discarded. It is considered more desirable to discard liquids that are within compartment 201 then to reuse those liquids. In other words, any liquids removed from compartment 201 are desirably not reintroduced back into compartment 201 at a later time. Therefore, any liquids removed from compartment 201 are disposed of, for example via a public drain.

Outlet 204 is desirably situated so that it receives liquids from the lowest point within compartment 201. In this manner, compartment 201 is fully drained.

Inlet 206 is also included. Inlet 206 receives liquid under pressure, thus causing the liquid to be directed upward within compartment 201. The liquid which is received by inlet 206 is for cleaning nozzle 106 and will be more fully described below.

Inlet 206 is desirably configured so that liquid flowing through inlet 206 flows through the center of compartment 201. Thus, inlet 206 is positioned at the center of the bottom of compartment 201. Fluid flowing under pressure through inlet 206 flows along dotted line C shown in FIG. 2 with a sufficient amount of pressure and for a sufficient amount of time to clean nozzle 106. In an exemplary embodiment of the present invention, the fluid flows through inlet 206 upward a sufficient distance to reach all of the interior surfaces of nozzle 106 when nozzle 106 is sitting within holster 200. In a further exemplary embodiment of the present invention, the fluid flows through inlet 206 for a minimum of thirty seconds (and at least once per day). Inlet 206 is desirably positioned to cause fluid to flow through the center of compartment 201 (line C) because, when nozzle 106 is placed in holster 200, the opening of nozzle 106 is desirably in the center of compartment 201. Thus, by orienting inlet 206 so that fluid flows through the center of compartment 201, the internal surfaces of nozzle 106 are cleaned as a result of impact by the fluid.

Within compartment 201, and attached to the exit of inlet 206, a spray nozzle 214 may be situated. This optional spray nozzle may direct fluid flowing through inlet 206 into any desired pattern in order to clean nozzle 106. In an exemplary embodiment of the present invention, a spray nozzle with a spray pattern of 25 degrees may be used.

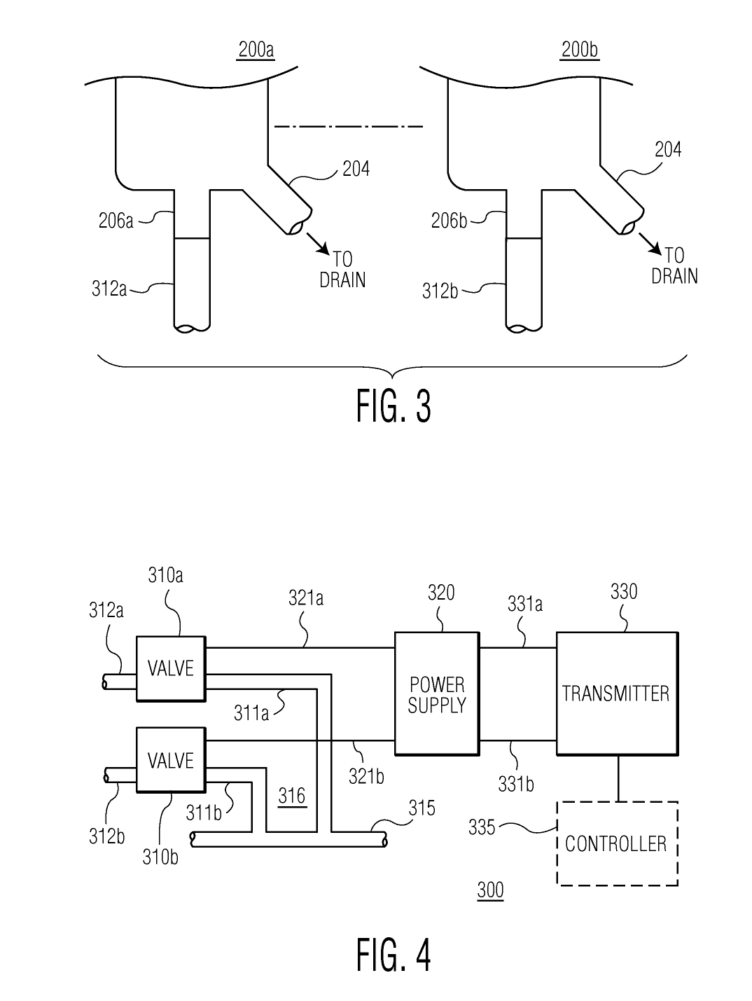

In many restaurants, there is more than one dispenser 100. Many restaurants have multiple dispensers 100 in order to accommodate the number of customers who wish to be served beverages. FIG. 3 illustrates that restaurants include multiple holsters 200 (200a-200b) in order to accommodate multiple dispensers 100. Each holster desirably includes a tube which allows fluid in each holster to flow into a drain. Each holster also includes a respective inlet 206 (206a-206b). Valve outlets 312a-312b provide pressurized fluid to each inlet 206a-206b respectively. Valve outlets 312a-312b are described in detail below.

FIG. 4 is a block diagram of cleaning apparatus 300 which, in accordance with an exemplary embodiment of the present invention, provides fluid to each holster 200. Cleaning apparatus 300 illustrated in FIG. 4 thus provides fluid under pressure which is received by inlet 106 and which is then propelled upwards towards nozzle 106 in order to clean nozzle 106.

Cleaning apparatus 300 shown in FIG. 4 is controlled by transmitter 330. Transmitter 330 allows fluid to be directed into inlet 106 at one or more specified times. Transmitter 330 may receive instructions from microprocessor based controller 335 which is programmed to instruct transmitter 330 to signal power supply 320. In an exemplary embodiment of the present invention, controller 335 is a DirectLOGIC Micro Programmable Logic Controller (DL05 PLC) which is manufactured by AutomationDirect. This programmable logic controller (PLC) is programmed in accordance with the DL05 Micro PLC User Manual, volumes 1 and 2, 6^{th} Edition, Rev. C, February 2013 which is hereby incorporated by reference in its entirety. Transmitter 330 via controller 335 is used to control valves 310a, 310b which permit fluid to flow into inlets 206 of respective holsters 200, thus cleaning respective nozzles 106 located within holsters 200. Thus, controller 335 has stored therein the current clock time (controller 335 increments the current clock time as time progresses so that the current clock time stored in controller 330 is correct). Basically, when the current clock time stored in controller 330 reaches a predetermined time, controller 330 instructs valves 310a,b to open, thus causing fluid to flow into holsters 200. After a predetermined period of time has elapsed, controller 335 instructs valves 310a,b to close, thus causing fluid to cease flowing into harnesses 200. Controller 335 then waits until the next time that valves 310a,b are to be opened, and then repeats the cycle of opening and closing valves 310a,b.

Controller 335 instructs valves 310a,b to open and close via power supply 320. In an exemplary embodiment of the present invention, power supply 320 is a PS-6012 manufactured by Altech Corp. and is installed and operated in accordance with the Altech Corp. PS-60 data sheet which is hereby incorporated by reference.

Controller 335 signals power supply 320 via controller outputs 331a,b. Power supply 320 subsequently provides 12 volt signals to valves 310a, b responsive to being signaled by outputs 331a,b respectively. Thus, a positive signal on controller output 331a causes power supply 320 to transmit a 12 volt signal on power supply output 321a. Furthermore, a positive signal on controller output 331b causes power supply 320 to transmit a 12 volt signal on power supply output 321b. When the positive signal is removed from controller output 331a, output 321a ceases to provide a 12 volt signal. When the positive signal is removed from controller output 331b, output 321b ceases to provide a 12 volt signal.

Valves 310a, b are valves which regulate flow of liquid. In an exemplary embodiment of the present invention, valves 310a, b are 12 VDC solenoid valves (i.e. valves with 12 volt relays) plastic ‘A″ manufactured by Zilong. When valves 310a,b receive 12 volt signals on their respective control inputs, the valves open and fluid provided at the valves’ input is allowed to flow out the valves' output. When the 12 volt signals are removed from each valves' control inputs, the valves close and fluid is not permitted to flow out of each valves' output. A desirable flow rate for the output of each valve is, for example, 1 gallon per minute.

Thus, power supply outputs 321a,b are connected between power supply 320 and valves 310a, b. When power supply 320 places a 12 volt signal on power supply output 321a, valve 310a opens. When power supply 320 places a 12 volt signal on power supply output 321b, valve 310b opens. When the respective 12 volt signals are removed from each respective power supply output, the respective valve closes.

Valves 310a,b receive fluid via valve inlets 311a,b respectively. Valve inlets may be pipes or tubes (e.g. flexible tubes) having, for example, a diameter of ⅜″. Valve inlets 311a,b receive fluid via pressurized fluid source 315. Pressurized fluid source 315 includes branch 316 which directs fluid under pressure to valve inlets 311a,b. Thus, when valve 310a opens, fluid from valve inlet 311a is permitted to flow through valve outlet 312a. Furthermore, when valve 310b opens, fluid from valve inlet 311b is permitted to flow through valve outlet 312b. Valve outlet 312a is connected to inlet 206a and valve outlet 312b is connected to inlet 206b. Thus, when valves 310a,b open, fluid is directed to holsters 200 in order to clean nozzles 106.

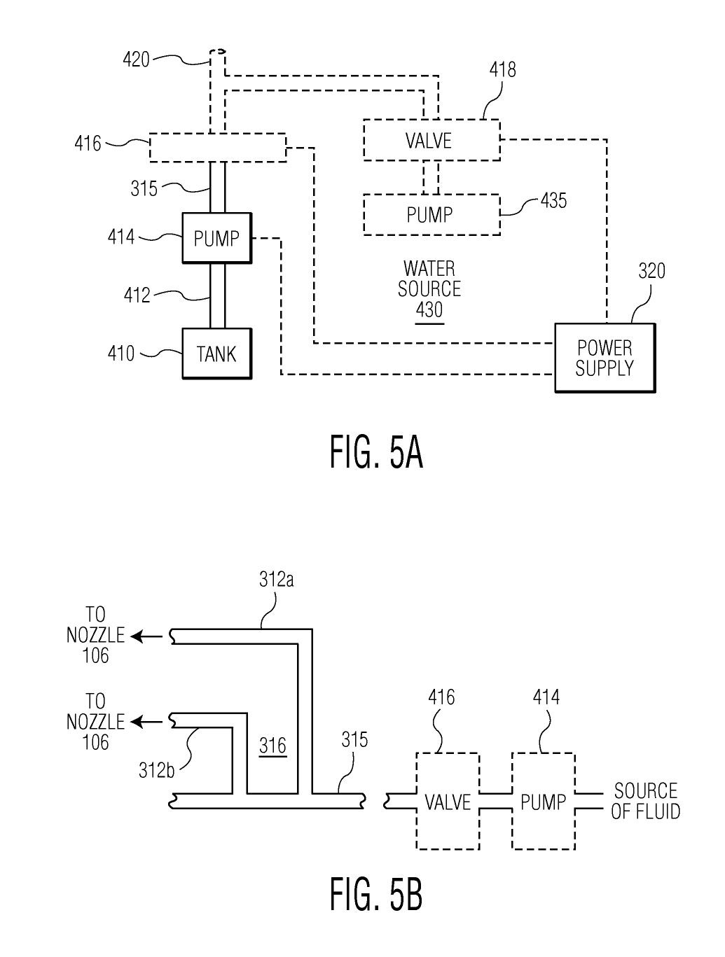

Pressurized fluid source 315 delivers pressurized fluid from a pressurized fluid source. The pressurized fluid source can be, for example, pressurized water from a municipal water source. Alternatively, the pressurized fluid source can be otherwise. For example, FIG. 5A illustrates an exemplary embodiment of the present invention in which fluid is stored in tank 410. Pump 414 pumps fluid out of tank 410 via supply tube 412 and into pressurized fluid source 315. Pump 414 may be actuated by controller 335 (via power supply 320). Pump 414 should have sufficient power (suction) to pump fluid out of tank 410 to holster(s) 200. In an exemplary embodiment of the present invention, pump 414 is a PM300 Perimax pump manufactured by Simply Pumps.

The fluid used to clean nozzle 106 may be for example a fluid which is safe for human consumption. Thus, a food grade solution is desirable as the fluid to be stored in tank 410. Exemplary food grade solutions include chlorine bleach (diluted 1 teaspoon to 1 quart of water, hydrogen peroxide (3%), and white distilled vinegar (5%). Other liquids may be used as the fluid within tank 410. Exemplary fluids which may be used within tank 410 include, for example: a) citric acid (with an exemplary concentration of between 2.5% and 35%) b) lactic acid (with an exemplary concentration of between 2.5% and 60%); and c) peracetic acid (with an exemplary concentration of between 1% and 22%). Other food sanitizing surface agents may also be used, including Steramine. Water may also constitute a “fluid.” Furthermore, fluid source 315 may optionally include a y-junction 420 and valves 416, 418 which allows the fluid flowing into pressurized fluid source 315 to alternate between the fluid stored in tank 410 and water obtained from a commercial water supply 430. Controller 335 can thus allow solution from tank 410 to clean nozzle(s) 106 for a first amount of time (by actuating valve 416), and to then allow water from a commercial water source to clean nozzle 106 for a second amount of time (by actuating valve 418).

In a further alternative embodiment of the present invention, tank 410 is eliminated and all cleaning is done simply using fluid from water source 430. Water source 430, may be, for example, a municipal water source. If the municipal water source is supplying water with sufficient pressure, then the pressure provided by the municipal water source may be sufficient to clean nozzle 106.

In a further exemplary embodiment of the present invention, an additional pump 435 is used with the water from water source 430 in order to increase the pressure of water being received from water source 430. Pump 435 may be used, for example, on demand. Thus, for example, a water pressure of 40 PSI from water source 430 may be desirable to clean nozzle 106. Pump 435 may be omitted if the water pressure from water source 430 is approximately 40 PSI or higher, Pump 435 may be included if the water pressure from water source 430 is below 40 PSI. If pump 435 is operated on an on demand basis, the pump 435 is activated if water pressure from water source 430 is below 40 PSI and pump 435 is deactivated (allowing water to pass through without boosting water pressure) if water pressure from water source 430 is 40 PSI or greater. A water pressure of 40 PSI is merely exemplary, and it is understood that a water pressure at which operation of pump 435 is desirable may be higher or lower depending upon individual circumstances.

In a further embodiment of the present invention, pump 435 may be used in combination with a fluid pressure detection switch. Thus, for example, if water pressure from the water source drops below a predetermined limit (e.g. 24 PSI) then the fluid pressure switch detects the lower pressure and activates the pump automatically. Thus, fluid is sprayed towards nozzle 106 without a pump assist if fluid pressure from the fluid source is above 24 PSI (for example) and fluid is sprayed towards nozzle 106 with a pump assist if fluid pressure from the fluid source is below 24 PSI (for example).

FIG. 4 and FIG. 5A illustrate various exemplary valves 310a, 310b and 418. One or ordinary skill in the art, however, may replace all of the various valves with a single valve (and/or a single source of fluid pressure). Thus, when the single valve is open (and/or fluid pressure is available), fluid is sprayed to all nozzles 106. When the single valve is closed (and/or fluid pressure is not available), fluid is not sprayed to all nozzles 106 (or to no nozzles 106). Exemplary locations to place a single valve include just prior to branch 316, or at a point downstream from pump 414 (if pump 414 is included) or pump 435 (if pump 435 is included).

FIG. 5B illustrates an alternative embodiment of the present invention. As shown, fluid is directed under pressure to different nozzles 106 of respectively different dispensers 100. Fluid arrives under pressure via pressurized fluid source 315 and is directed to valve outlets 312a,b via branch 316. There are several ways that fluid under pressure is provided to pressurized fluid source 315:
Pump 414 and valve 416 may be provided. Fluid from a source of fluid pumped with pressure via pump 414 to valve 416. When valve 416 is open, fluid under pressure arrives at pressurized fluid source 315. When valve 416 is closed, fluid is prevented from arriving at pressurized fluid source 315. Valve 416 and pump 414 can be controlled by controller 335 and power supply 320 as described above.
Pump 414 may be provided and valve 416 may be omitted. When pump 414 is on, fluid from a source of fluid is pumped with pressure via pump 414 to pressurized fluid source 315. When pump 414 is off, fluid from a source of fluid (not under pressure) is prevented from arriving at pressurized fluid source 315. Pump 414 can be controlled by controller 335 and power supply 320 as described above.
Valve 416 may be provided and pump 414 may be omitted. This embodiment may be used if the source of fluid is providing fluid to valve 416 under pressure. Fluid may be provided under pressure if the source of fluid is, for example, a municipal water supply. As previously explained, it is desirable for the amount of pressure in the fluid transmitted to pressurized fluid source to be sufficient to clean residue off of nozzles 106. Thus, when valve 416 is open, fluid from a source of fluid flows to pressurized fluid source 315. When valve 416 is closed, fluid from a source of fluid is prevented from arriving at pressurized fluid source 315.

Each of the above alternative embodiments enables pressurized fluid from a single source to arrive at pressurized fluid source 315, to flow through branch 316, and to then be sprayed onto multiple nozzles 106 via valve outlets 312a,b.

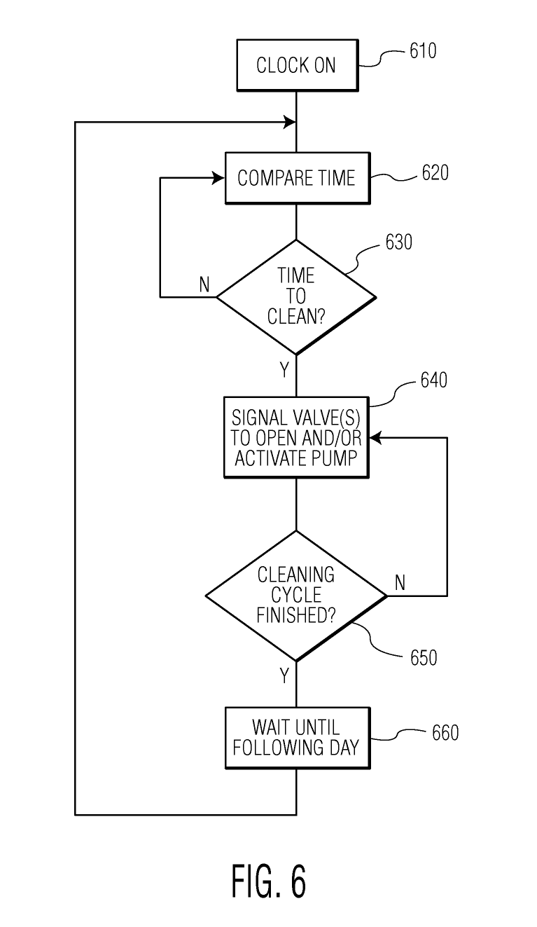

FIG. 6 is a flow chart diagram which illustrates an algorithm which may be used by controller 335 in accordance with an exemplary embodiment of the present invention. At step 610 a clock is activated with a time (e.g. the current time). At 620, the time from the clock activated at step 610 is compared with a prestored time. If, at step 630 the clock and the prestored time are the same, then at step 640 controller 335 signals for valves 310a,b to open so that fluid flows through valve outlets 312a,b and nozzle(s) 106 can be cleaned. The valves are signaled to remain open until, at step 650, enough time has passed that nozzle(s) 106 are clean. In an exemplary embodiment of the present invention, the valves are opened once a day for 30 seconds. One of ordinary skill in the art, however, will understand that the valves can be opened more than once per day and for more than 30 seconds. At step 660, processing waits until the following day. Processing then proceeds to step 620 where the loop is repeated.

In accordance with an exemplary embodiment of the present invention, it is desirable to allow fluid to be sprayed out of valve outlets 312a,b at predetermined times. Thus, when a predetermined time is reached (e.g. 4 AM, 8 AM etc.) valves 310a,b are opened and pressurized fluid flows out of valve outlets 312a,b and towards nozzle 106. The predetermined time may be chosen based upon times that beverages are typically not being served from dispenser 100 (such as a when a bar or restaurant is closed). At such times, nozzles 106 are resting in holsters 200 as they are not being used.

As previously explained, it may be desirable for dispenser 100 to be lifted out of holster 200 as quickly as possible. Furthermore, it may be desirable for dispenser 100 to be inserted into holster 200 (and thus “mated” to holster 200) as quickly as possible. This potential need to quickly mate dispenser 100 to holster 200 and to quickly remove dispenser 100 to holster 200 may add to the desirability of opening valves 310a,b based on time, and to not rely on a sensor. Thus, in this exemplary embodiment, there is no sensor that is needed to determine whether dispenser 100 is mated to holster 200 so that cleaning of nozzle 106 may be initiated. A sensor may have the disadvantage of not accurately detecting whether dispenser 100 is mated to holster 200. If a sensor does not detect that dispenser 100 is mated to holster 200 (even though in fact it is mated), then nozzle 106 will not be cleaned. In the exemplary embodiment, the possibility of a sensor not correctly determining that dispenser 100 is mated to holster 200 is a non-issue because no sensor is used for such detection. Nozzle 106 is simply cleaned with pressurized fluid from valve outlets 312a,b at a time when dispenser 100 is typically not being used.

Furthermore, the combination of a lack of a sensor to determine whether dispenser 100 is mated to holster 200 and permitting fluid to reach and clean nozzle 106 based on time of day may have desirability. A sensor may not reliably indicate whether nozzle 106 is in proper position to be cleaned within holster 200. Alternatively, the distance between where a sensor might be placed relative to holster 200 and the electronics to detect actuation of the sensor may be too far for signals from the sensor to be processed accurately. By permitting fluid to reach nozzle 106 based on time of day, the fluid can be sprayed towards nozzle 106 at a time when nozzle 106 is normally not being used (e.g. 4 AM). Thus, in an exemplary embodiment, nozzle 106 is reliably cleaned without relying on the complexity of a sensor and without spraying cleaning fluid towards nozzle 106 at times when dispenser 100 is being used (e.g. dinner hour on a Saturday night).

In an exemplary embodiment of the present invention, in order to ensure that sufficient pressure is delivered to each nozzle 102, valves 310a, b can be opened sequentially instead of at the same time. Thus, valve 310a can be opened, kept open, and closed before valve 310b is opened, kept open and closed.

While the above exemplary embodiment illustrates controller 335, it is understood that controller 335 can be replaced with other methods and apparatus for controlling cleaning apparatus 300. For example, controller 335 can be located at a remote site and can communicate with transmitter 330 via a Wi-Fi connection. Thus, a Wi-Fi receiver can receive signals over a wireless connection and can then signal power supply 320 to open and close valves in order to perform nozzle cleaning. It is understood that other forms of communication (wired and wireless) may also be used.

In actual practice, it is desirable for power supply 320 and controller 335 (or a Wi-Fi receiver if power supply 320 is controlled remotely) to be mounted in a box, such as a box with a screw on panel, in order to protect power supply 320 and controller 335 from tampering. Valves 310a and 310b can be mounted, for example, next to such a box and near tank 410 and/or a commercial water supply. The box and valves 310a,b can be located away from the bar area in order to avoid unnecessary crowding of the bar area. Valve outlets 312a,b can be routed through walls and/or floors to be connected to inlet 206. In this manner, power supply 320 and controller 335 can be placed in a desirable location in order to clean a plurality of dispensers 100 located in respectively different physical locations.

In an alternative embodiment of the present invention, the fluid that is flowing through valve outlets 312a,b can be heated. In this manner, effectiveness of the fluid in disinfecting nozzle 106 can be enhanced. A fluid heating mechanism (for example an instant hot water dispenser manufactured by InSinkErator) can be used to heat fluid before it reaches nozzle 106. Exemplary locations to place an instant hot water dispenser include along valve outlets 312a,b, valve inlets 311a,b, or anywhere before or after valve 416 and/or valve 418.

The above description and illustrations show fluid flowing into two valve outlets 312a,b via branch 316. It is understood, that the description of two valve outlets is merely exemplary, and the actual number of valve outlets may be two or greater. In this manner, two or more nozzles 106 of respective dispensers 100 can be included in accordance with the exemplary embodiments set forth above.

The above description describes opening valves and/or engaging a pump for a certain amount of time in order to clean nozzles 106. One or ordinary skill in the art will recognize that there are methods for determining how much cleaning fluid is sprayed on each nozzle 106. For example, instead of measuring the amount of time fluid is being sprayed onto nozzles 106, one can spray cleaning fluid onto nozzles 106 based on the amount of cleaning fluid being sprayed. Thus, for example, a dosing pump can be used to deliver a certain amount of cleaning fluid to nozzles 106. Permitting and then stopping cleaning fluid from spraying onto nozzles 106 can thus be a function of the amount of cleaning fluid sprayed, the amount of time during which cleaning fluid is sprayed, or both.

In a further exemplary embodiment of the present invention, an additional tube is directed towards the drain at which holster 200 drains. This additional tube can direct a sanitizing solution towards the drain to prevent fruit flies from accumulating near the drain. The sanitizing solution can be permitted to flow into the drain by use of the controller described above, and this sanitizing solution can be permitted to flow into the drain at a predetermined time of day.

In a further exemplary embodiment of the present invention, an electronic memory stores a record of when cleaning fluid is permitted to flow towards nozzle 106 (and optionally for how long). In this manner, a record is maintained to ensure compliance with a regular cleaning schedule.

The method and apparatus described above provides numerous advantages over the prior art:
The apparatus described above is attached to a holster using tubes. Therefore, the controller, power supply and valves can be located at a location away from holster 200. This is desirable because the area behind a bar is very crowded with machinery and beverages. The area under holster 200 can be kept clear for other machinery and beverages since fluid supply and fluid drain lines may be all that is required to be connected to holster 200. Thus, for example, controller 335 and power supply 320 may be located in a place which is away from customers and/or away from directly behind a bar. Controller 335 and power supply 320 can be housed in a “Bud” box and valves 310a,b can be located near the “Bud” box. Valve outlets 312a,b can be comprised of many feet of tubing. The tubing can be hidden under a bar counter and the tubing can extend to each dispenser 100. In this manner, multiple nozzles 106 can be cleaned without placing the equipment needed to clean nozzles 106 in inconvenient locations where a bar tender is attempting to work. The length of the tubing may determine the amount of power desirable in pump 414 to be able to pump fluid to each holster 200 to clean each nozzle 106.
Because controller 335 can begin allowing cleaning fluids to clean nozzle(s) 106 at any time, it is not necessary to detect whether nozzle 106 is in holster 200. Mechanisms to determine if nozzle 106 is in holster 200 can be expensive, require modifications to dispenser 100, and may not function correctly if such sensors are not properly engaged. With the exemplary embodiment described above, cleaning fluid can be directed at nozzle(s) 106 at a time that nozzle(s) 106 will normally be in their respective holster(s). Exemplary times when nozzle(s) 106 will be in their respective holster(s) will be times when a bar or restaurant is normally closed, such as LOAM (for a bar) or 4 AM (for a restaurant).
By streaming fluid at nozzles 102 when the bar or restaurant is closed, it is unnecessary to clean nozzles 102 after each use. When the bar or restaurant is closed and nozzles 102 are not being used, fluid can be directed to nozzles 102 for an extended period of time without interfering with a bartenders need to use the dispenser, especially during a busy time in the bar or restaurant.

While the present invention has been described herein with reference to exemplary embodiments, it should be understood that the invention is not limited thereto. Those skilled in the art with an access to the teachings herein will recognize additional modifications, applications, and embodiments within the scope thereof and additional fields in which the invention would be useful.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein, it is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. Apparatus for cleaning a plurality of beverage dispensers which sit in respective holsters, said apparatus comprising:
a) a plurality of cleaning solution conduits which are oriented to spray cleaning solution towards respective tops of said holsters;
b) at least one of a fluid valve and pump which alternatively permits and does not permit said cleaning solution to flow to said plurality of cleaning solution conduits, respectively;
c) a power supply which supplies one or more flow signal to said at least one of said fluid valve and said pump, wherein said valve transitions between permitting and not permitting flow responsive to transitioning of said flow signal, respectively;
d) a transmitter which signals said power supply to transition said flow signal to cause said at least one of said fluid valve and said pump to permit said cleaning solution to flow from a common source of said cleaning solution to said plurality of cleaning solution conduits.

2. Apparatus according to claim 1, further comprising a microprocessor based controller which signals via said transmitter to transition said one or more flow signals to cause said fluid valve to permit said cleaning solution to flow to said plurality of cleaning solution conduits, wherein signaling by said microprocessor based controller permits said cleaning solution to flow occurs for a predetermined duration.

3. Apparatus according to claim 1, wherein said cleaning solution is prevented from recirculating through said cleaning solution conduits after leaving said holsters.

4. Apparatus according to claim 1, further comprising drain lines that direct the cleaning solution leaving said holsters into a public drain.

5. Apparatus according to claim 1, wherein said holsters include an opening formed in a top of said holster and into which a nozzle of each of said plurality of beverage dispensers are inserted, wherein said cleaning solution conduits direct said cleaning solution to a center of said opening.

6. Apparatus according to claim 2, wherein said controller controls each of said fluid valves independently.

7. Apparatus according to claim 1, wherein said fluid valves receive said cleaning solution from a common source.

8. Apparatus according to claim 1, further comprising a tank for storing said cleaning solution and a pump for pumping said cleaning solution from said tank to said plurality of fluid valves.

9. Apparatus according to claim 1, further comprising a supply tube for transporting said cleaning solution, a splitter for splitting said supply tube into a plurality of sub-tubes, wherein each of said plurality of sub-tubes transports said cleaning solution to a respective one of said fluid valves.

10. Apparatus according to claim 1, wherein said cleaning solution conduits direct said fluid towards respective centers of said opening from a stationary location.

11. A method of cleaning a plurality of beverage dispensers which sit in respective holsters, said method comprising the steps of:
a) spraying cleaning solution towards respective tops of said holsters;
b) alternatively permitting and not permitting said cleaning solution to flow to said cleaning solution conduits from a common source and with pressure;
c) supplying flow signals to at least one of a fluid valve and said pump, wherein said at least one of said fluid valve and said pump transitions between permitting and not permitting flow responsive to transitioning of said flow signal;
d) signaling said power supply to transition said flow signal to cause said at least one of said fluid valve and said pump to permit said cleaning solution to flow from said common source of said cleaning solution to said cleaning solution conduits.

12. A method according to claim 11, wherein a microprocessor based controller signals to transition said flow signals to cause said fluid valves to permit said cleaning solution to flow to said cleaning solution conduits, wherein signaling by said microprocessor based controller, wherein signaling to permit said cleaning solution to flow occurs at a predetermined time of day and for a predetermined duration.

13. A method according to claim 11, wherein said cleaning solution is prevented from recirculating through said cleaning solution conduits after leaving said holsters.

14. A method according to claim 11, wherein drain lines direct the cleaning solution leaving said holsters into a public drain.

15. A method according to claim 11, wherein said holsters include an opening formed in a top of said holster and into which a nozzle of each of said beverage dispensers are inserted, wherein said cleaning solution conduits direct said cleaning solution to a center of said opening.

16. A method according to claim 12, wherein said controller controls each of said fluid valves independently.

17. A method according to claim 11, wherein said fluid valves receive said cleaning solution from a common source.

18. A method according to claim 11, wherein a tank stores said cleaning solution and a pump for pumping said cleaning solution from said tank to said plurality of fluid valves.

19. A method according to claim 11, wherein a supply tube transports said cleaning solution, a splitter splits said supply tube into a plurality of sub-tubes, and each of said sub-tubes transports said cleaning solution to a respective one of said fluid valves.

20. A method according to claim 11, wherein said cleaning fluid is directed towards respective centers of said opening from a stationary location.

21. A method according to claim 11, wherein said cleaning solution is selected from the group consisting of: a) citric acid; b) lactic acid; and c) peracetic acid.

22. A method according to claim 11, wherein said cleaning solution is heated.

23. Apparatus for cleaning a plurality of beverage dispensers, said apparatus comprising:
a) a holster upon which a beverage dispenser rests, said holster including an opening along a top thereof into which a nozzle of said dispenser is inserted;
b) a drain for dispensing of fluid which enters said holster, wherein said fluid is prevented from reentering said holster upon leaving a conduit which receives said fluid under pressure from outside of said holster and directs said fluid upwards towards a center of said opening from a stationary location at a bottom of said holster.
